(19) United States
(12) Patent Application Publication
(10) Pub. No.: US 2020/0238198 A1
(43) Pub. Date: Jul. 30, 2020

(54) Slop oil Treating Device

(71) Applicant: Cangzhou Xinchang Chemical Corporation, Cangzhou (CN)

(72) Inventors: Fei LI, Cangzhou (CN); Ping WANG, Cangzhou (CN)

(73) Assignee: Cangzhou Xinchang Chemical Corporation, Cangzhou (CN)

(21) Appl. No.: 16/412,455

(22) Filed: May 15, 2019

(30) Foreign Application Priority Data
Jan. 26, 2019 (CN) 201910075633.1

(51) Int. Cl. B01D 17/06; B01D 17/02

(52) U.S. Cl. CPC B01D 17/06; B01D 17/0214

(57) ABSTRACT

A slop oil treating device, including a pretreatment device, a solid-liquid separator, a demulsification nucleus-increasing treating device, a squeezing filter press, a three-phase separator, a buffer tank, a feeding pump, a circulating pump, a conveying pump, and an outputting pump. The slop oil is subjected to a pre-heating at a temperature ranging from 90° C. to 92° C. in the pretreatment device, and then conveyed to the solid-liquid separator for separation. Solid residue after a first-stage separation enters the squeezing filter press for solid-liquid squeezing. The squeezing filter press discharges the squeezed solid residue and conveys the squeezed waste water to the demulsification nucleus-increasing treating device. Oil and water after the first-stage separation enter the three-phase separator for second-stage high-speed centrifugal separation. Oil separated by the three-phase separator is conveyed to the buffer tank, and conveyed to a storage tank through the outputting pump.

### CROSS REFERENCE TO THE RELATED APPLICATIONS

This application is based upon and claims priority to Chinese Patent Application No. 201910075633.1, filed on Jan. 26, 2019, the entire contents of which are incorporated herein by reference.

### TECHNICAL FIELD

The present invention relates to the technical field of slop oil treatment, in particular to a slop oil treating device.

### BACKGROUND

Slop oil, also known as aged oil in the petrochemical industry, is an emulsified oil-water mixture with an extremely high stability, and generally, the basic sediment and water (BS&W) content of the slop oil ranges from 15% to 80%. This strong emulsion is not sensitive to chemical reagents, and oil-water separation phenomenon will generally not occur when the strong emulsion is placed for long time.

Laboratory studies have shown that, in oil-water emulsions, whether having a form of water-in-oil or oil-in-water, a solid suspension referred as an emulsion nucleus exists in each oil-water emulsion. The emulsion nucleus has a diameter ranging from 0.05 μm to 1200 μm and a specific gravity ranging from 1.2 g/cm³ to 2.8 g/cm³. The relationships between the diameter and the specific gravity of the solid suspension and the stability of the emulsion, between the physicochemical properties of the oil products and the stability of the emulsion, and between the physicochemical properties of the water and the stability of the emulsion are all complicated. It is extremely hard to use surfactant-based demulsifiers to treat aged oil, and the surfactant-based demulsifiers always target specific aged oil and are extremely unstable. After pretreatment with strong acid and strong alkali, the efficacy of some specific demulsifiers can be improved to a certain level, but new technical problems may be caused due to the treatment of the wastewater causing a secondary pollution.

The specific gravity of the aged oil is greater than that of the oil and smaller than that of the water. The aged oil is located at the oil-water interface in the three-phase separator. In the oil-water separation process, only when the proportion of the total solid suspensions is lower than a predetermined range (depending on the oil products), the demulsifier is effective. After the demulsification is realized by the demulsifier, the emulsion nucleuses generally enter the oil phase, while the emulsion nucleuses with relatively large particle sizes may enter the water phase, which will affect the content of oil in water (OIW). In summary, as long as the solid suspension regarded as the emulsion nucleus can be effectively removed, the oil-water emulsification problem will be solved smoothly. The current treating devices and processes need to be further improved.

### SUMMARY

The objective of the present invention is to overcome the deficiencies of the prior art, and to provide a slop oil treating device.

The present invention is achieved by the following technical solutions.

A slop oil treating device includes a pretreatment device, a solid-liquid separator, a demulsification nucleus-increasing treating device, a squeezing filter press, a three-phase separator, a buffer tank, a feeding pump, a circulating pump, a conveying pump, and an outputting pump. Slop oil in an oil tank is delivered to the pretreatment device through the feeding pump for pre-treatment. The slop oil is subjected to a pre-heating at a temperature ranging from 90° C. to 92° C. in the pretreatment device, and then conveyed to the solid-liquid separator for separation. Solid residue obtained after a first-stage separation enters the squeezing filter press for solid-liquid squeezing. The squeezing filter press discharges the squeezed solid residue, and conveys the squeezed waste water to the demulsification nucleus-increasing treating device, and then the squeezed waste water is conveyed to the pretreatment device through the circulating pump. The oil and water after the first-stage separation enter the three-phase separator for a second-stage high-speed centrifugal separation. The oil separated by the three-phase separator is conveyed to the buffer tank, and conveyed to a storage tank through the outputting pump. The water separated by the three-phase separator is conveyed to a waste water treatment workshop for processing. The emulsion separated by the three-phase separator is conveyed to the demulsification nucleus-increasing treating device for a nucleus-increasing treatment, and then returned to the pretreatment device and the solid-liquid separator.

Further, a regulating valve A is mounted on a slop oil conveying pipe, and the regulating valve A is configured to regulate a flow rate through the feeding pump.

Further, a regulating valve B is mounted on a steam conveying pipe, and the regulating valve B is configured to regulate a flow rate of steam conveyed to the pretreatment device.

Further, a gate valve is mounted in parallel between the pretreatment device and the slop oil conveying pipe.

Further, after a squeezing is performed by the squeezing filter press, the solid residue discharged has a water content of less than 65%, and an oil content of less than 2-3%.

Further, after a separation of the three-phase separator, basic sediment and water (BS &W) in the oil is 0.6-1.5%, and oil in water (OIW) concentration of the water is 55-150 ppm.

After a treatment of the solid-liquid separator, more than 96-99% of solid impurities in the slop oil can be removed. After entering the squeezing filter press, the solid residue is firstly dewatered under a positive pressure intensity by the squeezing filter press, which is also called slurry dewatering. Namely, a predetermined number of filter plates are closely arranged in a row under an action of strong mechanical force, and filter chambers are formed between surfaces of the filter plates. The material to be filtered is conveyed into the filter chamber under a strong positive pressure. A solid portion of the material to be filtered entering the filter chamber is trapped by a filter medium to form a filter cake, and a liquid portion is discharged from the filter chamber through the filter medium, thereby achieving the purpose of the solid-liquid separation. As the positive pressure intensity increases, the solid-liquid separation becomes more thorough.

The separation using the three-phase separator belongs to the second-stage separation. The separation of the three-phase separator is a high-speed centrifugal separation of oil and water. The second-stage separation brings three products: oil, water and emulsion.

After the first-stage treatment of the slop oil and then placing it for a predetermined time, a preliminary oil-water separation may also be achieved. The oil in water (OIW) concentration of the separated water can reach below 250 ppm, and the water content in the oil phase is between 7% and 15%. The composition of the solid impurities obtained in the first-stage separation is related to the characteristics of the slop oil, wherein the content of the free-state crude oil is equal to or less than 1.2% to 2.5%(by weight), the water content is 75% to 85% (by weight), and the organic matter content in the solid is between 25% and 35%. After the squeezing and filtering treatment, the water content of the solid residue can reach less than 65%. A mixture of the solid residue and a part of the treated oil can enter the coking production line as a raw material to avoid hazardous waste treatment. The water content of the oil phase from the outlet of the second-stage treatment ranges from 0.6% to 1.5%. With the change of the oil products, the oil inorganic solid content (excluding coke powder) is less than 0.8%, and the oil in water (OIW) concentration of the water ranges from 80 to 500 ppm, which is also related to the oil products.

Compared with the prior art, the advantages of the present invention are as follows. The present invention is designed in combination with the existing process conditions at the production site, corresponding changes are made according to different oil products and on-site process conditions, and the operating parameters are adjusted on the spot for different oil products. The optimum temperature of the pre-heating of the slop oil is 90-92° C., the back pressures of the receiving ends of the oil phase and the water phase should be less than 0.2 MPa (30 PSI), the inlet pressure of the slop oil is 0.2-0.4 MPa (30-60 psi), and the processing capacity of single device can reach 8-12 m³/h.

### BRIEF DESCRIPTION OF THE DRAWINGS

FIG. 1 is a structural schematic diagram of the present invention.

### DETAILED DESCRIPTION OF THE EMBODIMENTS

In order to make the objectives, technical solutions, and advantages of present invention clearer and more definite, the present invention will be further described in detail below in combination with the accompanying drawings and embodiments. It should be understood that the specific embodiments described herein are merely used to illustrate the present invention, and are not intended to limit the present invention.

The slop oils that appear in the petroleum and petrochemical industries have a common feature, namely, the oil-water mixture contains a large amount of sludge and solid impurities. It also confirms the research on the related emulsification mechanism in the laboratory from one aspect. The solid impurities such as sludge in slop oil has many sources. At present, the main sources of pollution in the domestic petroleum and petrochemical industry are listed as follows. First, muddy sand in the oil-producing stratum, it is directly related to the characteristics of the stratum and the success or failure of the well completion sand control; second, polymer flooding process in oil fields, it causes the polymer residue to enter the production fluid; third, well completion fluid, well killing fluid, newly-opened oil well production fluid, etc. of the oil fields are mixed into the production fluid. Due to the increased environmental protection requirements and supervision level, the oily sludge water in the oil field is mixed into the production liquid, and the final treatment pressure is transferred to the oil refining process. For the first two sources, slop oil will be continuously produced in the oil refining factory, which generally appears in the oil skimming processing tank of the wastewater treatment plant, or is stored at the bottom of the crude oil storage tank. The slop oil of the third source is produced due to irregular accidents of electric dehydration in the refining factory.

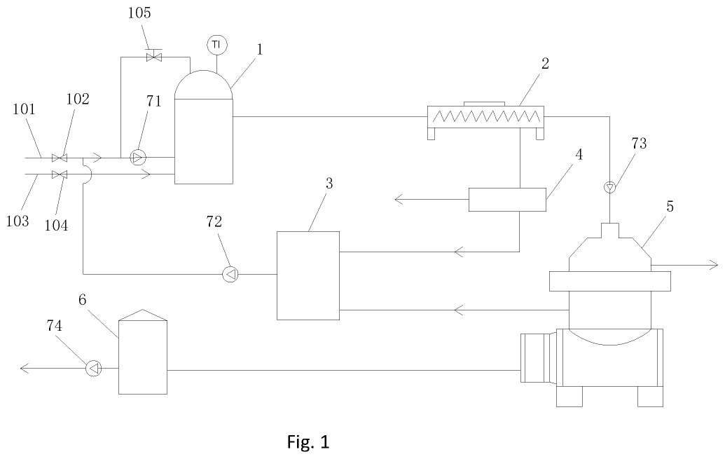

Referring to FIG. 1, FIG. 1 is a structural schematic diagram of the present invention.

The slop oil treating device includes the pretreatment device 1, the solid-liquid separator 2, the demulsification nucleus-increasing treating device 3, the squeezing filter press 4, the three-phase separator 5, the buffer tank 6, the feeding pump 71, the circulating pump 72, the conveying pump 73, and the outputting pump 74. Slop oil in an oil tank is delivered to the pretreatment device 1 through the feeding pump 71 for pre-treatment. The slop oil is subjected to a pre-heating at a temperature ranging from 90° C. to 92° C. in the pretreatment device 1, and conveyed to the solid-liquid separator 2 for separation. Solid residue obtained after a first-stage separation enters the squeezing filter press 4 for solid-liquid squeezing. The squeezing filter press 4 discharges the squeezed solid residue, and conveys the squeezed waste water to the demulsification nucleus-increasing treating device 3, and then the squeezed waste water is conveyed to the pretreatment device 1 through the circulating pump 72. Oil and water, after the first-stage separation, enter the three-phase separator 5 for second-stage high-speed centrifugal separation. Oil separated by the three-phase separator 5 is conveyed to the buffer tank 6, and conveyed to a storage tank through the outputting pump 74, water separated by the three-phase separator 5 is conveyed to a waste water treatment workshop for processing, and emulsion separated by the three-phase separator 5 is conveyed to the demulsification nucleus-increasing treating device 3 for a nucleus-increasing pretreatment, and then returned to the pretreatment device 1 and the solid-liquid separator 2.

The regulating valve A 102 is mounted on the slop oil conveying pipe 101, and the regulating valve A 102 is configured to regulate a flow rate through the feeding pump 71. The regulating valve B 104 is mounted on the steam conveying pipe 103, and the regulating valve B 104 is configured to regulate a flow rate of steam conveyed to the pretreatment device 1. The gate valve 105 is mounted in parallel between the pretreatment device 1 and the slop oil conveying pipe 101.

After a squeezing is performed by the squeezing filter press 4, the solid residue discharge has a water content of less than 65%, and an oil content of less than 2-3%. After separation of the three-phase separator 5, basic sediments and water (BS &W) of the oil is 0.6-1.5%, and oil in water (OIW) concentration of the water is 55-150 ppm.

After a treatment of the solid-liquid separator 2, more than 96-99% of solid impurities in the slop oil can be removed. After entering the squeezing filter press 4, the solid residue is firstly dewatered under a positive pressure intensity by the squeezing filter press 4, which is also called slurry dewatering. Namely, a predetermined number of filter plates are closely arranged in a row under an action of strong mechanical force, filter chambers are formed between surfaces of the filter plates, the material to be filtered is conveyed into the filter chamber under a strong positive pressure. The solid portion of the material to be filtered entering the filter chamber is trapped by a filter medium to form a filter cake, and the liquid portion is discharged from the filter chamber through the filter medium, thereby achieving the purpose of the solid-liquid separation. As the positive pressure intensity increases, the solid-liquid separation becomes more thorough.

The separation using the three-phase separator 5 belongs to the second-stage separation. The separation of the three-phase separator 5 is a high-speed centrifugal separation of oil and water. The second-stage separation brings three products: the oil having a BS&W of 0.6-1.5%, the water having an OIW of 55-150 ppm, and the emulsion having a BS&W of 5-12%. The contents of the three products are related to the oil products.

After the first-stage treatment of the slop oil and then placing for a predetermined time, a preliminary oil-water separation may also be achieved. The oil in water (OIW) concentration of the separated water can reach below 250 ppm, and the water content in the oil phase is between 7% and 15%. The composition of the solid impurities obtained in the first-stage separation is related to the characteristics of the slop oil, wherein the content of the free-state crude oil is equal to or less than 1.2% to 2.5% (by weight), the water content is 75% to 85% (by weight), and the organic matter content in the solid is between 25% and 35%. After the squeezing and filtering treatment, the water content of the solid residue can reach less than 65%. A mixture of the solid residue and a part of the treated oil can enter the coking production line as a raw material to avoid hazardous waste treatment. The water content of the oil phase from the outlet of the second-stage treatment ranges from 0.6% to 1.5%. With the change of the oil products, the oil inorganic solid content (excluding coke powder) is less than 0.8%, and the oil in water (OIW) concentration of water phase ranges from 80 ppm to 500 ppm, which is related to the oil products as well.

The present invention is designed in combination with the existing process conditions at the production site, corresponding changes are made according to different oil products and on-site process conditions, and the operating parameters are adjusted on the spot for different oil products as well. The optimum temperature of the pre-heating of the slop oil is 90-92° C., the back pressures of the receiving ends of the oil phase and the water phase should be less than 0.2 MPa (30 PSI), the inlet pressure of the slop oil is 0.2-0.4 MPa (30-60 psi), and the processing capacity of the single device can reach 8-12 m³/h.

The above descriptions are merely the preferred embodiments of the present invention, and are not intended to limit the present invention. Any modification, equivalent replacement and improvement made within the spirit and principles of the present invention should be included in the scope of the present invention.

What is claimed is:

1. A slop oil treating device, comprising: a pretreatment device, a solid-liquid separator, a demulsification nucleus-increasing treating device, a squeezing filter press, a three-phase separator, a buffer tank, a feeding pump, a circulating pump, a conveying pump, and an outputting pump; wherein,
the feeding pump is connected to the pretreatment device, slop oil in an oil tank is delivered to the pretreatment device through the feeding pump for a pre-treatment;
the pretreatment device is connected to the solid-liquid separator, the slop oil is subjected to a pre-heating at a temperature ranging from 90° C. to 92° C. in the pretreatment device, and conveyed to the solid-liquid separator for a first-stage separation;
the squeezing filter press is connected to the solid-liquid separator and the emulsification nucleus-increasing treating device, respectively, the circulating pump is connected to the emulsification nucleus-increasing treating device and the pretreatment device, respectively, a solid residue after the first-stage separation enters the squeezing filter press for a solid-liquid squeezing; the squeezing filter press discharges a squeezed solid residue and conveys squeezed waste water to the demulsification nucleus-increasing treating device, and then the squeezed waste water is conveyed to the pretreatment device through the circulating pump; and
the three-phase separator is connected to the conveying pump, the demulsification nucleus-increasing treating device and the buffer tank, respectively, the conveying pump is connected to the solid-liquid separator, the outputting pump is connected to the buffer tank, an oil and water mixture after the first-stage separation enters the three-phase separator for a second-stage high-speed centrifugal separation; an oil separated by the three-phase separator is conveyed to the buffer tank, and conveyed to a storage tank through the outputting pump, water separated by the three-phase separator is conveyed to a waste water treatment workshop for a processing, and an emulsion separated by the three-phase separator is conveyed to the demulsification nucleus-increasing treating device for a nucleus-increasing pretreatment, and then returned to the pretreatment device and the solid-liquid separator.

2. The slop oil treating device of claim 1, wherein, a first regulating valve is mounted on a slop oil conveying pipe, and the first regulating valve is configured to regulate a flow rate through the feeding pump.

3. The slop oil treating device of claim 2, wherein, a second regulating valve is mounted on a steam conveying pipe, and the second regulating valve is configured to regulate a flow rate of steam conveyed to the pretreatment device.

4. The slop oil treating device of claim 3, wherein, a gate valve is mounted in parallel between the pretreatment device and the slop oil conveying pipe.

5. The slop oil treating device of claim 1, wherein, after a squeezing is performed by the squeezing filter press, the solid residue discharged has a water content of less than 65%, and an oil content of less than 2-3%.

6. The slop oil treating device of claim 1, wherein, after a separation of the three-phase separator, basic sediments and water (BS&W) of the oil are 0.6-1.5%, and oil in water (OIW) concentration of the water is 55-150 ppm.
